(19) United States
(12) Patent Application Publication
(10) Pub. No.: US 2005/0068038 A1
(43) Pub. Date: Mar. 31, 2005

(54) Electronic apparatus recharged via signal I/O terminal

(76) Inventors: Winston Hsiao, Sindian City (TW); Larry Tsai, Taipei City (TW)

Correspondence Address: PERKINS COIE LLP;PATENT-SEA, P.O. BOX 1247, SEATTLE, WA, 98111-1247, US

(21) Appl. No.: 10/726,310

(22) Filed: Dec. 1, 2003

(30) Foreign Application Priority Data
Sep. 30, 2003 (TW) 92127008

(51) Int. Cl. H02J 7/00

(52) U.S. Cl. 324/426

(57) ABSTRACT

Signal I/O terminals originally in electronic apparatus now serve as rechargeable terminals thereof.

### CROSS-REFERENCE TO RELATED APPLICATION(S)

This application claims priority to Taiwan Patent Application No. 092127008, filed Sep. 30, 2003, which is incorporated herein in its entirety by reference.

### TECHNICAL FIELD

The present invention generally relates to an electronic apparatus via signal I/O terminals to recharge power, and more particularly to a multifunction meter for using signal I/O examining terminals as recharging terminals.

### BACKGROUND

In general, current electronic apparatus needs power supply to implement work, such as, communication mobile phone, pager, personal digital assistance (PDA), multifunction meter or multimeter, electric meter or meter, oscilloscope, digital camera, video camera, walkman, pen recorder, and global positioning system (GPS). Functions of these electronic apparatus may be different, but they all need power supply to work. There are many ways to get power supply, such as disposable battery or rechargeable battery. However, lithium battery is a mainstream rechargeable battery nowadays.

A schematic diagram of popular electronic apparatus, as shown in FIG. 1A, has an electronic apparatus 100 containing an accumulator or condenser 101, an electronic device 102, an indicator 103, a switch 104, and I/O terminals 105. The accumulator or condenser 101 is a main power supply for the electronic device 102 with charging path mainly through charger 107 to process independently. Generally, the accumulator or condenser 101 can use storage battery or the lithium battery that mention above. There is always an independent charger 107 for the accumulator or condenser 101.

An electronic apparatus, such as multimeter 110, as shown in FIG. 1B, contains an indicator 111, a switch 112, function menu 114, 115, signal I/O terminal for signal examining 116. The indicator 111 mainly displays the electronic apparatus status, which can be designed as tip-indicator or digital liquid crystal displayer. When recharging, this kind of accumulator or condenser of the electronic apparatus, as shown in FIG. 1C, needs to take battery 121 off and to be inserted into a charger 122.

Another electronic apparatus structure is shown in FIG. 2A, in which an electronic device apparatus 200 comprises an accumulator or condenser 201, an electronic device 202, an indicator 203, a switch 204, I/O terminals 205, and a charger 207. Compared with the previous example, as shown in FIG. 2B, the electronic apparatus 210 itself provides charge terminals 217, which means user needless to take accumulator/condenser or battery off and find the independent charger to process charging. Comparing with these two, no matter to process charging through the charger 107 or charger terminals 207, the accumulator or condenser charging process is through an independent path.

Traditional electronic appliance uses internal built-in circuits to recharge battery or cell, which needs charging through DC Jack or Molex connecting terminals independently, and charging terminals or jack is only for single purpose use as shown in FIG. 1C and FIG. 2B. As to higher safety approvals requirement, the traditional electronic appliance have focus on not only power supplying but also recharging all needs further treatment to the charging terminals or outlet.

Although current multimeter provides with accumulator or condenser, switch and I/O terminals, however, the I/O terminal is only for signal I/O and do not have any other charging function for using path. For instance, as shown in FIG. 1B, meter 101 provides with the indicator 111, the switch 112, and the signal I/O terminals 116.

Current charge terminals or jack are for single purpose use only, such as charging or power supply route. This kind of current charger, including charging terminals and jack, may be designed and used separately, such as accessory charger or DC Jack in FIG. 1C or charging terminals in FIG. 2B.

Furthermore, all charging methods are required to be used in danger-free electronic devices or appliance. For industry situation, such electronic devices are operated under higher voltage compared to domestic or school appliances, and hence severe safety approval is required relatively to CAT-III 600V. When use of these charger terminal or jack, its original creepage distance protective circuits and fuse's durable level need to increase to CAT-111.600V or safety standard related. Therefore, the used of electronic devices for house-hood or school, their charging method of safety standard level request is lower, and not suitable for industry use.

### SUMMARY

For the invention background mention above, the connecting terminals with only single purpose use provided by traditional method that creates many problems. The main purpose of this invention is that original I/O terminals can be applied to process charging for the internal part of accumulator or condenser and do not need other outlet or charging terminal.

It is another object of this invention that electronic devices with built-in accumulator or condenser can enhance the safety approval thereof and user safety is also increased.

It is a further object of this invention that user needless to distinguish between the signals of I/O terminal and charge terminals so that this really brings a lot of convince.

It is a still further object of this invention to make the size of electronic devices much smaller.

It is furthermore object of this invention that there is no need to have different process for different functions of electronic devices in operation.

According to the objects above, this invention provides an alternative charging route by using original I/O terminals to charge internal accumulator or battery without further charge terminals. This invention can be applied to any electronic device with build-in accumulator or battery without redundant charge terminal or jack to increase convenience in use. For electronic devices used in industry, the required safety approval can be met in this invention, and hence safety use is increased in the industrial condition.

This invention also provides handheld, portable, or desktop model of any kind of testing instrument, which comprises multi-miter, process calibrator, process meter/multi-meter, and oscilloscope products. No matter which mechanical or electrical switch is employed, the original I/O, control/inspect or measure/produce signals terminals will serve as internal charging route of battery;

on the other hand, the internal charging route of battery can serve as I/O, control/inspect or measure/produce signals terminals.

This invention provides a testing instrument that contains a testing device, an accumulator or condenser, a terminal, and a switch. The testing device is used for inspecting an object, and the accumulator or condenser provides power to the testing device. The terminal provides the testing device that provides signals transferring route between the testing device and the object, and also provide a charging route for the accumulator. The switch is used for determining status of the testing device, such as testing mode or charging mode.

This invention also provides an electricity meter that comprises a meter for inspecting electric characteristic of an object, an accumulator for providing power to the meter, two terminals for providing electric signals transferring route of the meter and charging route of the accumulator, a switch for determining status of the meter, and a display device for displaying the status of said meter, wherein the status includes testing mode or charging mode. The meter can be multi meter or oscilloscope.

This invention provides an apparatus charged via signal terminals, which comprises an electronic device, an accumulator for providing electric power to the electric device, a terminal for providing signals transferring route of the electronic device and a charging route for the accumulator, and a switch for determining status of the electronic device, such as processing mode or charging mode.

### BRIEF DESCRIPTION OF THE DRAWINGS

The foregoing aspects and many of the attendant advantages of this invention will become more readily appreciated as the same becomes better understood by referring to the following detailed description, when taken in conjunction with the accompanying drawings, wherein:

FIG. 1A illustrates a schematic representation of a popular structure of an electronic device;

FIG. 1B illustrates a schematic representation of a popular structure of multi meter charger;

FIG. 1C illustrates a schematic representation of a popular structure of single purpose of charger indicator;

FIG. 2A illustrates a schematic representation of another structure of electronic apparatus with charging terminal of indicator;

FIG. 2B illustrates a schematic representation of another structure of multi meter with charging terminal attached;

FIG. 3 illustrates a schematic representation of an electronic device structure in accordance with this invention;

FIG. 4 illustrates a schematic representation of an electronic device structure with indicator attached in accordance with this invention;

FIG. 5 illustrates a schematic representation of a multifunction meter in accordance with this invention; and

FIG. 6 illustrates a schematic representation of a mobile phone in accordance with this invention.

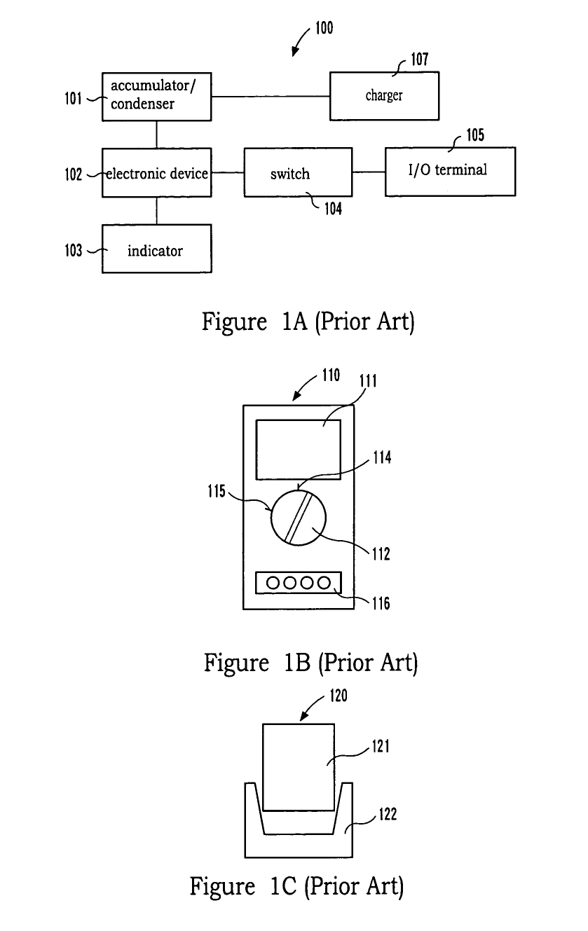

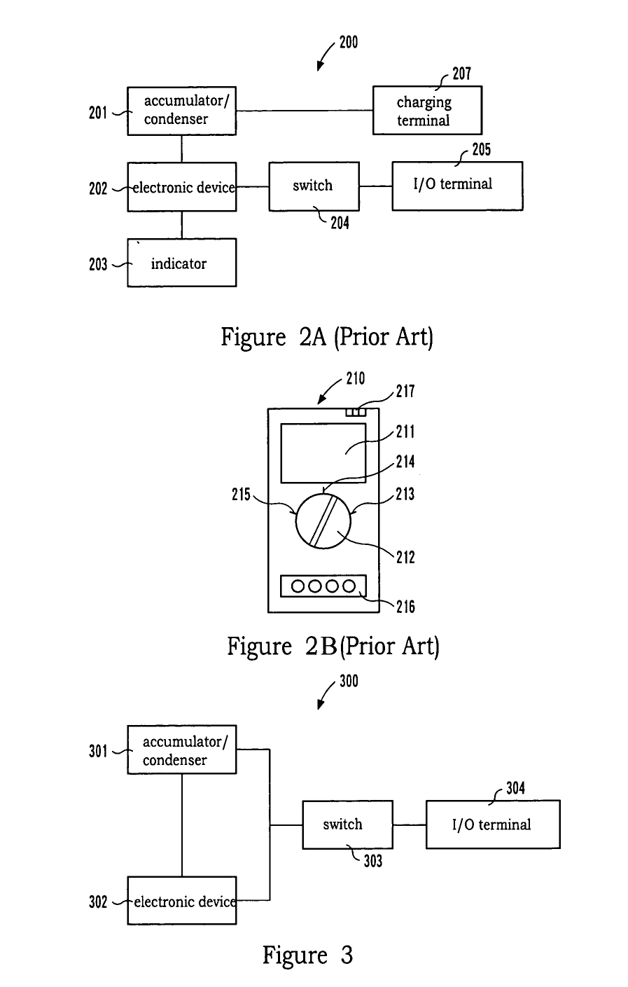

### DETAILED DESCRIPTION

Some sample embodiments of the present invention will now be described in greater detail. Nevertheless, it should be recognized that the present invention can be practiced in a wide range of other embodiments besides those explicitly described, and the scope of the present invention is expressly not limited except as specified in the accompanying claims.

Then, the components of the different elements are not shown to scale. Some dimensions of the related components are exaggerated and meaningless portions are not drawn to provide a more clear description and comprehension of the present invention.

This invention provides a testing apparatus including a testing device for inspecting an object, an accumulator for supplying power to the testing device, a terminal, and a switch for determining status of the testing device, wherein the status includes testing mode or charging mode. The terminal provides signals transferring route between the testing device and the object, and also provides a charging route for the accumulator. When only one terminal is used for charging route, the terminal has two ends that one connects to ground and the other connects to charging circuits.

The accumulator can be lithium battery. The testing device can be a temperature sensor, a gaseous detector, or a fluid sensor. When the testing apparatus comprises another terminal, the testing device can be a multimeter, an oscilloscope, a process calibrator, or a process meter. The testing apparatus can include a display device to show whether the status of the testing device is on testing mode or on charging mode.

This invention also provides an electricity meter which comprises a meter for inspecting electric characteristic of an object, an accumulator for providing power to the meter, two terminals for providing electric signals transferring route of the meter and charging route of the accumulator, a switch for determining whether status of the meter is on testing mode or on charging mode, and a display device for displaying the status of the meter. The meter can be a multifunction meter or an oscilloscope.

This invention further provides an apparatus charged via signal terminals. The apparatus comprises an electronic device, an accumulator for providing electric power to the electric device, a terminal providing signals transferring route of the electronic device and a charging route for the accumulator, and a switch for determining whether status of the electronic device is on processing mode or on charging mode.

The electronic device can be a mobile communicating device or a personal digital assistant. The accumulator can be lithium battery, NiMH (Nickel Metal hydride) battery, or NiCd (nickel cadmium) battery. The switch can detect the electronic device in processing mode or in charging mode automatically. Further, a display device can be used for displaying the status of the electronic device.

One embodiment of an apparatus charged via I/O terminals, as shown in FIG. 3. The apparatus includes an accumulator or condenser 301, an electronic device 302, a switch 303, and I/O terminal 304. The accumulator or condenser 301 not only has rechargeable function, but power supply also. The electronic device 302 can be used for inspecting electricity of an object, such as electric current, resistance, voltage, inductance, capacitance, impedance and frequency. It can also inspect other characteristic of object, such as temperature, magnetic field intensity, electromagnetic wave for mobile device, spectrum analysis, and fluid analysis. The electronic device 302 also can be use on other function, such as mobile phone, PDA (Personal Digital Assistance), digital image device or digital camera, Walkman, MD (Mini Disk), CD, MP3 or Pen Recorder. The I/O terminal 304 is used for signal terminal I/O of the electronic device 301 and electricity charging route of the accumulator 302. Generally, the switch 303 is used for determining the processing status or charging status of the electronic device 301.

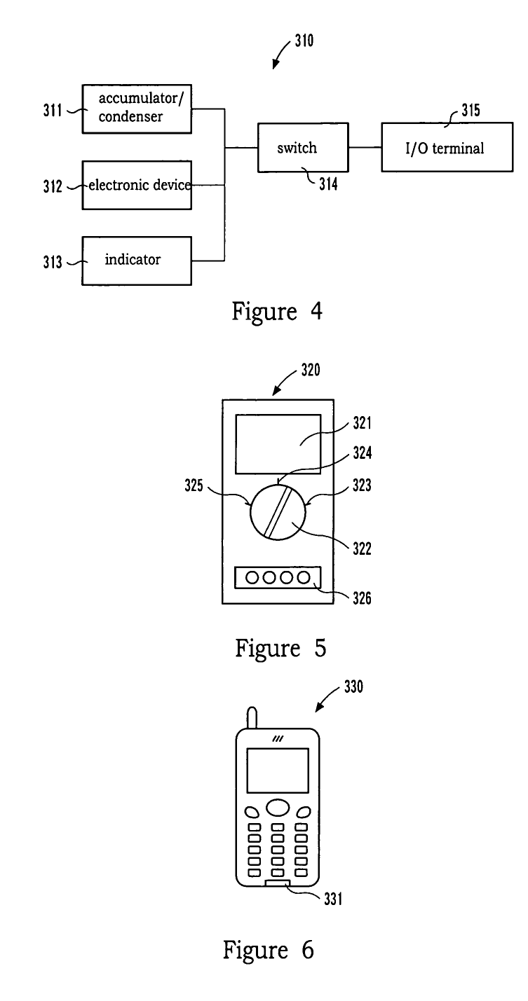

In general, the electronic apparatus will have an indicator device, as shown in FIG. 4, there are an accumulator 311, an electronic device 312, an indicator 313, a switch 314, and I/O terminals 315 are exhibited. The Indicator 313 is for displaying the status of electronic device 312, there are the status here includes on/off switch, power charging status, and the electronic device 312 in use status.

When a meter is applied in this invention, as shown in FIG. 5, a multifunction meter 320 includes a display device 321, a switch 322 with three statuses 323, 324, and 325, and four I/O terminals 326. The I/O terminals 326 can be divided into two terminals for examining high level signals and two for examining low level signals, or other configuration. What more important of that is two of the four I/O terminals 326 can be used as charging route of battery. A possible design for the three statuses 323, 324, and 325 of the switch 322 can be off 325, processing 324, and charging 323. Another possible design is both of the power charging status and off can be the 325, a first processing mode 324, and a second processing mode 323. The display device 321 can be traditional tip with scale to exhibit electric potential, current, resistance, or other electric characteristic such as electric capacitance, inductance, frequency examined by the meter. A more popular display device 321 uses liquid crystal display device so it does not need to use the Indicator and Scale in pair and can obtain the status value in a sample way.

According to another embodiment of this invention, any handheld style, potable, or desktop different testing instrument model can be process calibrator, process meter or oscilloscope product. No matter which mechanical or electrical switch is employed, the original I/O, control/inspect or measure/produce signals terminals will serve as internal charging route of battery; on the other hand, the internal charging route of battery can serve as I/O, control/inspect or measure/produce signals terminals.

Beside applied to meter as shown in FIG. 5, this invention can be used on mobile phone 330 as well. Generally, the signal-transmitting terminal and power-charging terminal are separated and independent. In this embodiment, signal transmitting terminal 331 can serve as power charging terminal as well. The different portion is that switch is built in the mobile phone and can automatically tell whether the terminal 331 is on the I/O signal position or the power charging position.

Except the above-mentioned meter or mobile phone as electronic devices of this invention, any other electronic devices or equipment with signals I/O terminals or ports can be applied to this invention. For example, a PDA, its signal transmitting and charging terminals are like design of mobile phone.

The main advantage of this invention is that it can be applied to any electronic device with built in charging battery and circuits that needless to lower their safety level, but to increase its safety approval. The operating safety is therefore secured. Furthermore, for any related inspecting and electronic apparatus, they do not need any other power-charging terminal especially for the electronic product with small size. It is very convenient and easy to use the electronic devices. For the design of electronic product, the designers or manufactures do not need to have different design for signal I/O and changing terminals.

Although specific embodiments have been illustrated and described, it will be obvious to those skilled in the art that various modifications may be made without departing from what intends to be limited solely by the appended claims.

1. A testing apparatus, comprising:
a testing device for inspecting an object;
an accumulator for supplying power to said testing device;
a first terminal for providing signals transferring route between said testing device and the object, and also providing a charging route for said accumulator; and
a switch to determine status of said testing device, wherein said status includes testing mode or charging mode.

2. The testing apparatus according to claim 1, further comprising a second terminal.

3. The testing apparatus according to claim 2, wherein said second terminal electrically connects to ground.

4. The testing apparatus according to claim 2, wherein said testing device is a multimeter.

5. The testing apparatus according to claim 2, wherein said testing device is an oscilloscope.

6. The testing apparatus according to claim 2, wherein said testing device is a process calibrator.

7. The testing apparatus according to claim 2, wherein said testing device is a process meter.

8. The testing apparatus according to claim 1, wherein said testing device is a temperature sensor.

9. The testing apparatus according to claim 1, wherein said testing device is a gaseous detector.

10. The testing apparatus according to claim 1, wherein said testing device is a fluid sensor.

11. The testing apparatus according to claim 1, wherein said accumulator is selected from the group consisting of lithium battery, hydrogen-nickel battery, and cadmium-nickel battery.

12. The testing apparatus according to claim 1, further comprising a display device to show the status of said testing apparatus.

13. An electricity meter, comprising:
a meter for inspecting electric characteristic of an object;
an accumulator for providing power to said meter;
two terminals for providing electric signals transferring route of said meter and charging route of said accumulator;
a switch to determine status of said meter, wherein said status includes testing mode or charging mode; and
a display device for displaying the status of said meter.

14. The electricity meter according to claim 13, wherein said meter is a multifunction meter.

15. The electricity meter according to claim 13, wherein said meter is an oscilloscope.

16. An apparatus charged via signal terminals, said apparatus comprising:
an electronic device;
an accumulator for providing electric power to said electric device;
a terminal providing signals transferring route of said electronic device and a charging route for said accumulator; and
a switch to determine status of said electronic device, wherein said status includes processing mode or charging mode.

17. The apparatus according to claim 16, wherein said electronic device is a mobile communicating device.

18. The apparatus according to claim 16, wherein said electronic device a personal digital assistant.

19. The apparatus according to claim 16, wherein said accumulator is selected from the group consisting of lithium battery, nickel-metal-hydride battery, and nickel-cadmium battery.

20. The apparatus according to claim 16, wherein said switch detects said electronic device in processing mode or in charging mode automatically.

21. The apparatus according to claim 20, further comprising a display device for displaying the status of said electronic device.
